(19) United States
(12) Patent Application Publication
(10) Pub. No.: US 2013/0114290 A1
(43) Pub. Date: May 9, 2013

(54) DISPLAY MODULE

(71) Applicant: Ping LEE, Hsin-Chu (TW)

(72) Inventor: Ping LEE, Hsin-Chu (TW)

(73) Assignee: AU OPTRONICS CORP., Hsin-Chu (TW)

(21) Appl. No.: 13/401,929

(22) Filed: Feb. 22, 2012

(30) Foreign Application Priority Data
Nov. 7, 2011 (TW) 100140594

(51) Int. Cl. G09F 13/18; G09F 13/14

(52) U.S. Cl. 362/602; 362/97.1

(57) ABSTRACT

A display module includes a metal rear bezel, a backlight module, a driver circuit board and a heat dissipation film. The metal rear bezel includes a carrier surface and a back surface opposite to the carrier surface. The backlight module includes a light reflective sheet disposed on the carrier surface. The light reflective sheet includes a light reflective sheet and a heat dissipation surface opposite to the light reflective sheet. The driver circuit board is attached to the back surface of the metal rear bezel. The heat dissipation film is disposed on the heat dissipation surface. At least a portion of the heat dissipation film is overlapped with the driver circuit board.

### TECHNICAL FIELD

The present invention relates to display modules, and more particularly to a display module with excellent heat dissipation.

### BACKGROUND

With the development of technology, tablet personal computers appear after desktop computers and notebook computers, and the tablet personal computers are thinner than the notebook computers. The tablet personal computers generally have touch panel displays so that users can directly operate the computers on the displays with fingers. Compared to the notebook computers, personal digital assistants and smart phones, the tablet personal computers have compact appearance and large display size at the same time. The tablet personal computers are convenient, and become more and more popular.

Conventional tablet personal computers generally use thin film transistor liquid crystal display. The display includes a backlight module. The backlight module includes a rear bezel and a driver circuit board adjacent to the rear bezel. In order to reduce weight and thickness of the rear bezel, the rear bezel is made of hollowed stainless steel. However, since the coefficient of heat conductivity of stainless steel and the area of heat dissipation of the rear bezel is small, the rear bezel cannot quickly dissipate the heat produced by electronic components on the driver circuit board. This brings obvious mura formed on the display, or a cover lens of the touch panel display has a relatively high temperature to touch.

In order to solve above problems, a copper foil layer or a graphite layer is added between the rear bezel and the driver circuit board to increase heat radiating efficiency. However, since there is a plurality of electronic components behind the display and the size of the display is limited, the added copper foil layer or the added graphite layer makes the electronic components more crowded. This may bring appearance of Newton's ring phenomenon on the touch panel display. In addition, the copper foil layer is easily folded and cannot be restored to original shape. Also, the graphite layer cost too much. Thus, there is room to improve.

### SUMMARY

Therefore, the present invention provides a display module including a metal rear bezel, a backlight module, a driver circuit board and a heat dissipation film. The metal rear bezel includes a carrier surface and a back surface opposite to the carrier surface. The backlight module includes a light reflective sheet disposed on the carrier surface. The light reflective sheet includes a light reflective sheet and a heat dissipation surface opposite to the light reflective sheet. The driver circuit board is attached to the back surface of the metal rear bezel. The heat dissipation film is disposed on the heat dissipation surface. At least a portion of the heat dissipation film is overlapped with the driver circuit board.

The present invention further provides a display module including a metal rear bezel, a driver circuit board, a light reflective sheet, a light guide plate, a light source and a heat dissipation film. The metal rear bezel has a carrier surface and a back surface opposite to the carrier surface. A center portion of the metal rear bezel is removed away to form a hollow portion. The driver circuit board is disposed on the back surface of the metal rear bezel. The light reflective sheet has a light reflective surface and a heat dissipation surface opposite to the light reflective surface. The light guide plate is disposed on the light reflective surface of the light reflective sheet. The light source is disposed adjacent to the light guide plate and is electrically connected with the driver circuit board. The heat dissipation film is disposed between and thermally contacts the heat dissipation surface of the light reflective sheet and the carrier surface of the metal rear bezel. An edge portion of the heat dissipation film is overlapped with the driver circuit board. A center portion of the heat dissipation film is exposed from the hollow portion of the metal rear bezel.

### BRIEF DESCRIPTION OF THE DRAWINGS

The present invention will become more readily apparent to those ordinarily skilled in the art after reviewing the following detailed description and accompanying drawings, in which:

FIG. 1 is a schematic, back view of a display module according to a first embodiment of present invention.

FIG. 2 is a schematic, cross-sectional view taken along line A-B of FIG. 1.

FIG. 3 is a schematic, back view of another display module according to a second embodiment of present invention.

FIG. 4 is a schematic, back view of a further display module according to a third embodiment of present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

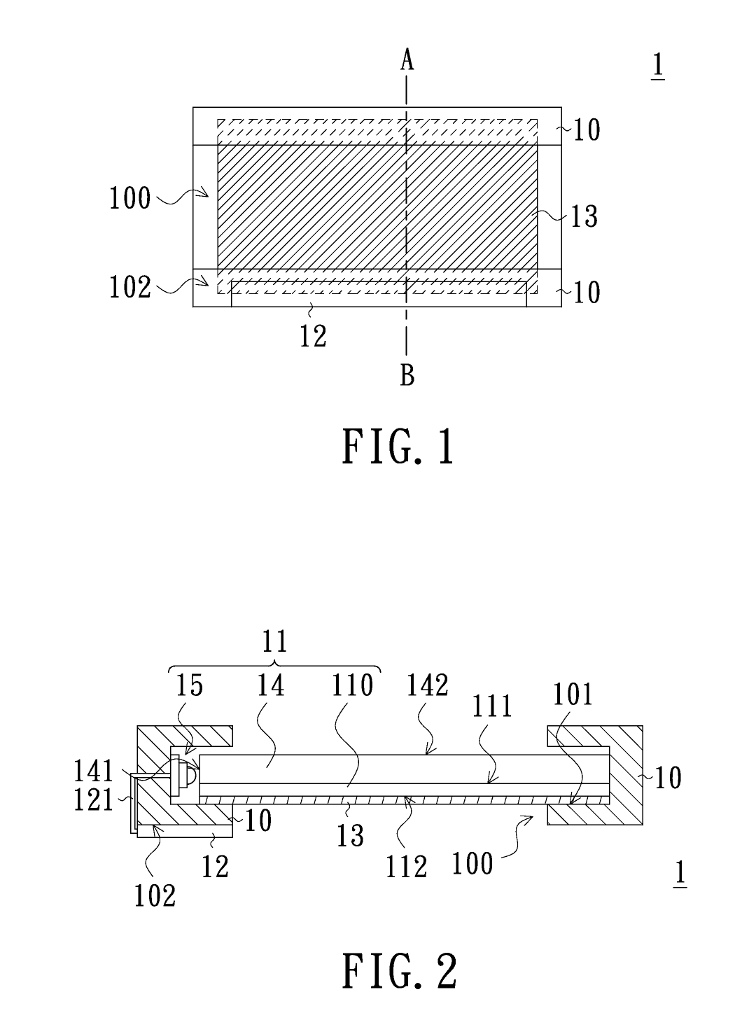

FIG. 1 is a schematic, back view of a display module 1 according to a first embodiment of present invention. FIG. 2 is a schematic, cross-sectional view taken along line A-B of FIG. 1. The display module 1 may be, without limitation, applied as a thin film transistor liquid crystal display (TFT-LCD) of a tablet personal computer.

The display module 1 includes a metal rear bezel 10, a backlight module 11, a driver circuit board 12 and a heat dissipation film 13. The metal rear bezel 10 has a carrier surface 101 and a back surface 102 opposite to the carrier surface 101. The backlight module 11 has a light reflective sheet 110 disposed on the carrier surface 12 of the metal rear bezel 10. The light reflective sheet 110 has a light reflective surface 111 and a heat dissipation surface 112 opposite to the light reflective surface 111. The driver circuit board 12 is attached to the back surface 102 of the metal rear bezel 10. The heat dissipation film 13 is formed on the heat dissipation surface 112 of the light reflective sheet 110, and at least a portion of the heat dissipation film 13 is overlapped by the driver circuit board 12. In the embodiment, a lower edge portion of the heat dissipation film 13 is overlapped by the driver circuit board 12, as shown in FIG. 1. The lower edge portion of the heat dissipation film 13 is sandwiched between the carrier surface 101 of the metal rear bezel 10 and the heat dissipation surface 112 of the light reflective sheet 110. The heat dissipation film 13 may be made of copper, graphite or other material which has a coefficient of heat transfer greater than 200.

The metal rear bezel 10 transfers heat produced by electronic components on the driver circuit board 12 to the heat dissipation film 13, and the heat dissipation film 13 dissipates the heat into the surrounding. This can avoid the heat accumulating inside the display module 1 to harm the electronic components. Due to the heat dissipation film 13, when a surrounding temperature is 60° C. or 25° C., a temperature inside the display module 1 is 4.4° C. lower than that of a conventional display module without the heat dissipation film 13.

The detail configuration of the display module 1 is described as follow.

The backlight module 11 further includes a light guide plate 14 and a light source 15. The light guide plate 14 is set on the light reflective surface 111 of the light reflective sheet 110. The light guide plate 14 includes a light incident surface 141 and a light exit surface 142. The light exit surface 142 is disposed above the light reflective surface 111 of the light reflective sheet 110. The light exit surface 142 is perpendicular to and connects with the light incident surface 141. The light source 15 is positioned at one side of the light guide plate 14, facing the light incident surface 141. Light beams emitted from the light source 15 go into the light guide plate 14 from the light incident surface 141 and go out the light guide plate 14 from the light exit surface 142. The light beams from the light exit surface 142 function as a surface light source for a display panel (not shown) disposed on the backlight module 11.

The light source 15 may be a light emitting diode. The light source 15 is electrically connected to the driver circuit board 12 by a flexible printed circuit board 121, and the driver circuit board 12 supplies electric energy to the light source 15 for emitting light beams.

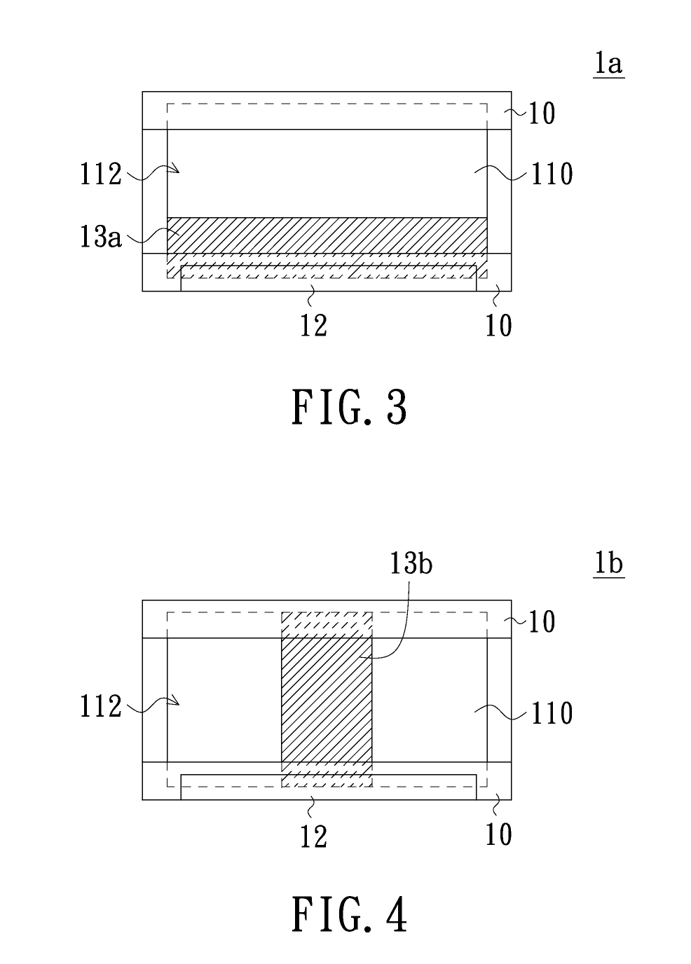

In order to reduce weight and volume of the display module 1, the metal rear bezel 10 may be partially hollowed. The heat dissipation film 13 is exposed from the hollowed portion of the metal rear bezel 10. In this embodiment, the heat dissipation film 13 completely covers the heat dissipation surface 112 of the light reflective sheet 110, and the area of the hollow portion of the metal rear bezel 10 is smaller than that of the heat dissipation film 13. However, in a second embodiment of the present invention, referring to FIG. 3, a heat dissipation film 13a of another display module 1a is positioned at one side of the heat dissipation surface 112 and partially covers the heat dissipation surface 112. The heat dissipation film 13a extends along a transverse direction of the heat dissipation surface 112. In a third embodiment of the present invention, referring to FIG. 4, a heat dissipation film 13b of a further display module 1b is positioned at a middle portion of the heat dissipation surface 112 and partially covers the heat dissipation surface 112. The heat dissipation film 13b extends along a longitudinal direction of the heat dissipation surface 112. In the second embodiment and the third embodiment, it is obvious that the area of the heat dissipation film 13a, 13b is smaller than that of the heat dissipation surface 112. The area of the dissipation film 13a, 13b may be, without limitation, one third of the heat dissipation surface 112.

It should be understood that the area ratio between the dissipation film 13a, 13b and the heat dissipation surface 112 can be altered according to different requirements.

In summary, the dissipation film 13, 13a, 13b is formed on the light reflective sheet 110, and is positioned between the light reflective sheet 110 and the metal rear bezel 10 and partially overlapped with the driver circuit board 12. Thus, the heat produced by the working electronic components on the driver circuit board 12 can be dissipated into the surrounding by the metal rear bezel 10 and the heat dissipation film 13, 13a, 13b, so as to avoid the heat accumulating inside the display module 1, 1a, 1b to harm the electronic components. In addition, the heat dissipation film 13, 13a, 13b can be attached to the heat dissipation surface 112 of the light reflective sheet 110 by adhesive or be formed on the heat dissipation surface 112 by painting. Thus, the heat dissipation film 13, 13a, 13b does not interfere other elements of the display module 1, 1a, 1b while increasing heat dissipation surface area for the display module 1, 1a, 1b.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A display module, comprising:
a metal rear bezel including a carrier surface and a back surface opposite to the carrier surface;
a backlight module including a light reflective sheet, the light reflective sheet disposed on the carrier surface, the light reflective sheet including a light reflective surface and a heat dissipation surface opposite to the light reflective surface;
a driver circuit board attached to the back surface of the metal rear bezel; and
a heat dissipation film disposed on the heat dissipation surface of the light reflective sheet, at least a portion of the heat dissipation film overlapped with the driver circuit board.

2. The display module according to claim 1, wherein the heat dissipation film is attached to the heat dissipation surface by adhesive or is formed on the dissipation surface by painting.

3. The display module according to claim 1, wherein the heat dissipation film has a coefficient of heat transfer greater than 200.

4. The display module according to claim 1, wherein the heat dissipation film is made of copper or graphite.

5. The display module according to claim 1, wherein the backlight module further comprises:
a light guide plate disposed on the light reflective surface of the light reflective sheet, the light guide plate including a light incident surface and a light exit surface, the light exit surface disposed above the light reflective surface; and
a light source disposed beside the light incident surface of the light guide plate.

6. The display module according to claim 5, wherein the driver circuit board is electrically connected to the light source.

7. The display module according to claim 1, wherein the area of the heat dissipation film is smaller than that of the heat dissipation surface of the light reflective sheet.

8. The display module according to claim 1, wherein the metal rear bezel comprises a hollow portion at a center thereof, and the heat dissipation film is partially exposed from the hollow portion.

9. A display module comprising:
a metal rear bezel having a carrier surface and a back surface opposite to the carrier surface, a center portion of the metal rear bezel being removed away to form a hollow portion;
a driver circuit board disposed on the back surface of the metal rear bezel;
a light reflective sheet having a light reflective surface and a heat dissipation surface opposite to the light reflective surface;
a light guide plate disposed on the light reflective surface of the light reflective sheet;
a light source disposed adjacent to the light guide plate and electrically connected with the driver circuit board; and
a heat dissipation film disposed between and thermally contacting the heat dissipation surface of the light reflective sheet and the carrier surface of the metal rear bezel, an edge portion of the heat dissipation film being overlapped with the driver circuit board, a center portion of the heat dissipation film being exposed from the hollow portion of the metal rear bezel.

10. The display module according to claim 9, wherein the heat dissipation film is attached to the light reflective sheet by adhesive or is formed on the light reflective sheet by painting.

11. The display module according to claim 9, wherein the heat dissipation film has a coefficient of heat transfer greater than 200.

12. The display module according to claim 9, wherein the heat dissipation film is made of copper or graphite.

13. The display module according to claim 9, wherein the light guide plate has a light incident surface and a light exit surface, the light exit surface is disposed above the light reflective surface of the light reflective sheet; and the light source is disposed beside the light incident surface of the light guide plate.

14. The display module according to claim 13, wherein the driver circuit board is electrically connected to the light source by a flexible printed circuit board.

15. The display module according to claim 9, wherein the area of the heat dissipation film is smaller than that of the heat dissipation surface of the light reflective sheet.
